(19) United States
(12) Patent Application Publication
(10) Pub. No.: US 2017/0015032 A1
(43) Pub. Date: Jan. 19, 2017

(54) TRIM COMPONENT FOR VEHICLE INTERIOR

(71) Applicant: Shanghai Yanfeng Jinqiao Automotive Trim Systems Co., Ltd., Plymouth, MI (US)

(72) Inventors: Peter Thielhorn, Mulheim an der Ruhr (DE); Guersel Kasikci, Mulheim an der Ruhr (DE); Werner Klusmeier, Lubbecke (DE)

(21) Appl. No.: 15/240,806

(22) Filed: Aug. 18, 2016

Related U.S. Application Data
(63) Continuation-in-part of application No. PCT/EP2015/053479, filed on Feb. 19, 2015.

(30) Foreign Application Priority Data
Mar. 18, 2014 (DE) 102014003751

(51) Int. Cl. B29C 45/14; B60R 13/02; B29C 37/00; B29B 11/06; B29B 11/14

(52) U.S. Cl. CPC B29C 45/14688; B29B 11/06; B29B 11/14; B29C 37/0025; B60R 13/02; B29C 2045/14713; B29K 2105/20

(57) ABSTRACT

A method for producing a trim component for vehicle interior is disclosed. The method may produce multilayer molded bodies (e.g. interior compartments/fittings for vehicles) in which a reverse side of a leather material is backed with a plastic by injection molding. In order to prevent the leather material from being damaged by the injection pressures and/or temperatures during the in-mold injection molding process, the method provides for introducing untreated leather material into the injection mold.

### CROSS REFERENCE TO RELATED APPLICATIONS

The present application is a continuation in part of International Application No. PCT/EP2015/053479 titled “MULTILAYERED MOLDED BODY FOR VEHICLE INTERIORS AND METHOD FOR PRODUCING SUCH MOLDED BODIES” filed Feb. 19, 2015.

### FIELD

The present invention relates to a trim component for a vehicle interior.

The present application claims priority from and the benefit of and incorporates by reference in entirety of the following application(s): (a) International Application No. PCT/EP2015/053479 titled “MULTILAYERED MOLDED BODY FOR VEHICLE INTERIORS AND METHOD FOR PRODUCING SUCH MOLDED BODIES” filed Feb. 19, 2015; (b) German Patent Application No. DE 102014003751 titled “MULTILAYERED MOLDED BODY FOR VEHICLE INTERIORS AND METHOD FOR PRODUCING SUCH MOLDED BODIES” (Mehrschichtiger Formkörper für Fahrzeuginnenausstattungen sowie Verfahren zur Herstellung solcher Formkörper), filed Mar. 18, 2014 (German Patent Office).

### BACKGROUND

It is known to provide trim panels for vehicle interior. It is also known to form the trim panels by plastic injection molding. It is also known to provide a leather material to cover the trim panels.

It would be advantageous to provide an improved method to injection mold a plastic material onto the reverse/back side of the leather material to form a finished trim panel with a leather cover within a mold apparatus. It would also be advantageous to provide an improved trim panel with a leather cover.

### SUMMARY

The present invention relates to a method for producing a trim component for a vehicle interior comprising a leather material backed with a plastic material in an apparatus comprising a tool. The method comprises the steps of placing an untreated leather material into the tool, introducing molten plastic material into the tool to form a formed component comprising the leather material and the plastic material and removing the formed component from the tool. The untreated leather material may comprise leather that is tanned. Embossing may be introduced in or on the leather material by the tool. A surface of the leather material opposite from the plastic material may be provided with a color finish after the formed component is removed from the tool. The apparatus may comprise an injection mold and the plastic material may be introduced under pressure into a chamber of the injection mold. A protective coating may be applied to the color finish after application of the color finish. The formed component may comprise a multilayer molded body of plastic material and leather material. The untreated leather material may comprise at least one of (a) tanned leather; (b) uncolored leather; (c) scrap leather; (d) crust leather. The leather material may be at least one of (a) cut from dried leather; (b) flat and uncurried; (c) unstretched and untreated. The leather material may be placed on the tool such that a reverse side of the leather material is aligned toward the chamber of the injection mold. The leather material may undergo minimal drawing with residual stretching prior to being introduced into the tool; the leather material may be moistened prior to being introduced into the tool. Prior to the introduction of the molten plastic material the reverse side of the leather material may be coated with a barrier layer; the barrier layer may comprise a barrier film impermeable to the plastic material. The molten plastic material may be introduced into the tool at a temperature of from 170 degrees Celsius to 250 degrees Celsius. The plastic material may comprise a thermoplastic material.

The present invention also relates to a trim component made by a method. The method comprises the steps of placing an untreated leather material into the tool, introducing a molten plastic material into the tool to form a formed component comprising the leather material on the plastic material and removing the formed component from the tool. The untreated leather material may comprise leather that is tanned; the untreated leather material may comprise leather that has elasticity to withstand being formed into the formed component. Embossing is introduced in or on the leather material by the tool. The trim component may comprise a painted formed component. The leather material may be affixed to a plastic material to form a molded body of the formed component. The trim component may comprise the formed component coated with one of paint and a coating; the coating comprises at least one of abrasion protection, ultra-violet light protection, glass finish, matte finish, color, humidity or moisture resistant material, clear coating, varnish and/or protective coating. The plastic material may comprise at least one of a thermoplastic material, polypropylene and/or polyolefin.

The present invention also relates to a method for producing a trim component for a vehicle interior comprising a leather material backed with a plastic by injection molding in an apparatus comprising a tool. The method comprises the steps of providing an untreated leather material, placing the untreated leather material into the tool, introducing a molten plastic material into the tool to form a formed component comprising the leather material on the plastic material and removing the formed component from the tool. Embossing may be introduced in or on the leather material by the tool. The untreated leather material may comprise leather that is tanned. Embossing may be introduced substantially during introducing of the molten plastic material.

The present invention also relates to a method for producing multilayer molded bodies, particularly interior fittings for vehicles, in which a reverse side of a leather material is backed with a plastic by injection molding. The method comprises providing a flat, uncurried leather material, introducing the leather material into an injection mold such that the reverse side of the leather material is aligned toward an injection chamber of the injection mold, introducing a molten plastic material under pressure into the injection chamber of the injection mold and removing the multilayer molded body of plastic and leather material from the injection mold. An embossing is introduced in or on the leather material during the introducing of the molten plastic material. In the method, the uncurried leather material is a leather product which while tanned, has not yet been or not fully stretched and treated. A surface of the leather material opposite from the plastic may be provided with a color finish after the molded body is removed from the injection mold. A protective coating, particularly a clear varnish, is applied to the color finish subsequent the application of said color finish. In the method, the uncurried leather material is crust leather; the leather material may be cut from a dried leather; the leather material may be tanned leather. The leather material may undergo minimal drawing with residual stretching prior to being introduced into the injection mold. The leather material may be moistened prior to being introduced into the injection mold. Prior to the introduction of the molten plastic material, the reverse side of the leather material may be coated with a barrier layer (e.g. a barrier film) which is impervious to the plastic material. The molten plastic material may be introduced into the injection mold at a temperature from 170 degrees Celsius to 250 degrees Celsius. A thermoplastic is preferably used as the plastic material, preferably polyolefin and particularly polypropylene. A multilayer molded body, particularly an interior fitting for vehicles, may comprise a leather material affixed to a plastic, characterized in that the molded body is produced pursuant to the method.

### FIGURES

FIG. 1A is a schematic perspective view of a vehicle according to an exemplary embodiment.

FIG. 1B is a schematic perspective cut-away view of a vehicle showing a vehicle interior according to an exemplary embodiment.

FIG. 2A is a schematic perspective front view of a vehicle interior trim component according to an exemplary embodiment.

FIG. 2B is a schematic perspective front view of a vehicle interior trim component according to an exemplary embodiment.

FIG. 2C is a schematic perspective back view of the vehicle interior trim component according to an exemplary embodiment.

FIG. 3 is a schematic perspective front view of a vehicle interior trim component according to an exemplary embodiment.

FIGS. 4A to 4E are schematic cross-section views of a method for forming a formed part for the vehicle interior according to an exemplary embodiment.

FIG. 4F is a schematic perspective view of a formed part for the vehicle interior according to an exemplary embodiment.

FIGS. 5A to 5E are schematic cross-section views of a method for forming a formed part for the vehicle interior according to an exemplary embodiment.

FIG. 5F is a schematic perspective view of a formed part for the vehicle interior according to an exemplary embodiment.

FIG. 6A is a schematic perspective view of a color finished being applied to the formed part according to an exemplary embodiment.

FIG. 6B is a schematic perspective view of a protective coating being applied to the formed part to form a finished part (i.e. trim component) according to an exemplary embodiment.

FIG. 6C is a schematic perspective view of the finished part according to an exemplary embodiment.

FIGS. 7A to 7C are schematic flow diagrams of process steps for forming a trim component according to an exemplary embodiment.

FIG. 8 is a schematic flow diagram of process steps for forming a component according to an exemplary embodiment.

FIG. 9 is a schematic perspective view of a leather sheet according to an exemplary embodiment.

FIG. 10 is a schematic cross-section view of a trim component according to an exemplary embodiment.

### DESCRIPTION

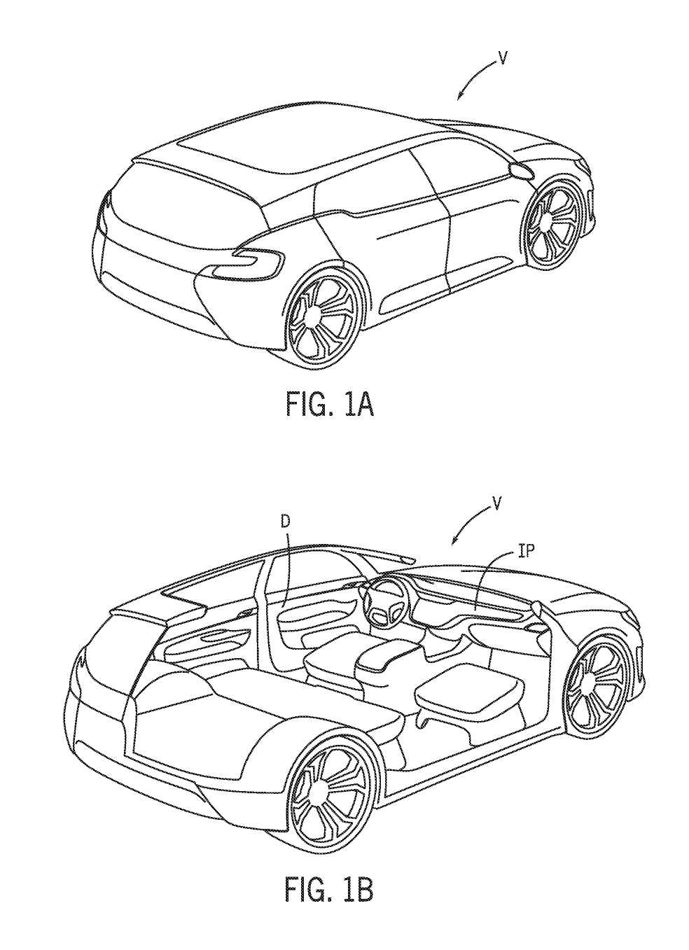

Referring to FIGS. 1A and 1B, a vehicle V is shown including an interior I with an instrument panel IP and doors D. According to an exemplary embodiment, interior components of vehicle V such as instrument panel IP and doors D may include trim components; a trim component may comprise a substrate and a cover. According to an exemplary embodiment, the substrate may be made of a plastic material; the cover may be made of a leather material; the cover provides a visible surface to vehicle occupants according to an exemplary embodiment. According to an exemplary embodiment, a trim component may provide ancillary features on the backside of the trim component for various purposes (e.g. to improve structure integrity, to increase tensile strength, to attach the trim component to the vehicle, or to attach other parts to the trim component, etc.).

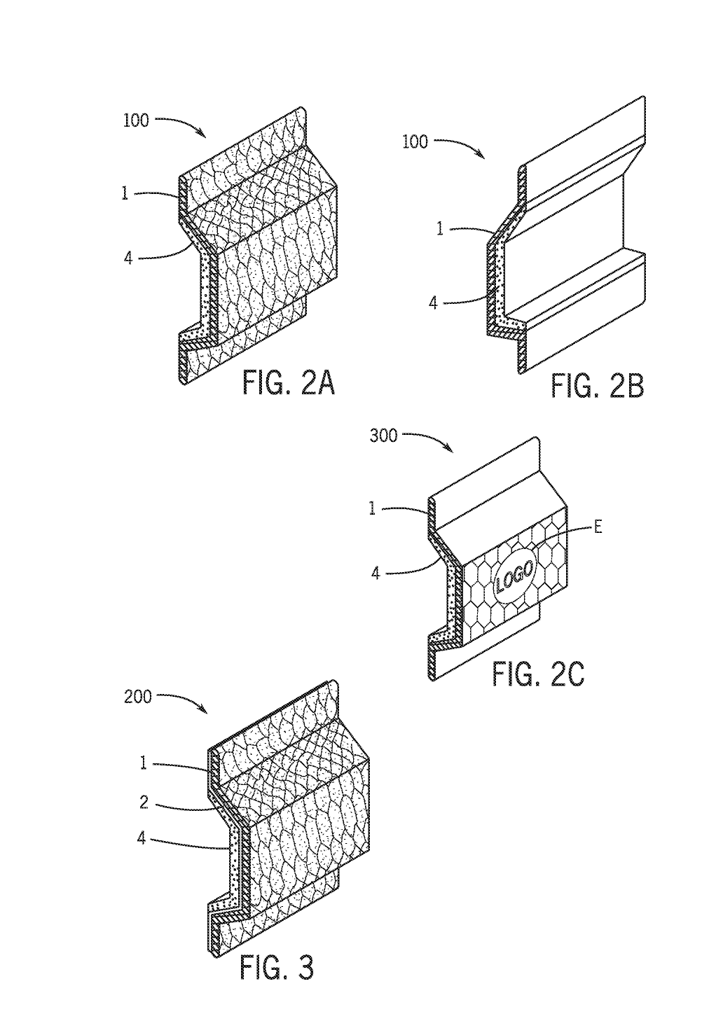

As shown schematically in FIGS. 2A and 2B, a trim component 100 comprises a substrate 4 and a cover 1 (i.e. a leather material). According to an exemplary embodiment, substrate 4 is made of a plastic material (e.g. molded thermoplastic material such as containing polypropylene); cover 1 is made of a leather material; cover 1 provides a visible surface to vehicle occupants.

According to an exemplary embodiment, the leather material for the cover may provide a texture or pattern (e.g. a natural leather appearance) when in an untreated form (e.g. tanned but not stretched, etc.). As shown schematically in FIGS. 2A and 2C, leather material 1 may be embossed with a pattern (e.g. a pattern as indicated to visually enhance the appearance or a form E such as a logo). According to an exemplary embodiment, the embossment pattern may be a pattern such as a skin pattern and/or any applicable shape or form selected for the vehicle interior. As shown schematically in FIG. 2C, the visible surface of leather material 1 on a trim component 300 may be embossed with form E shown as logo (or other full or partial pattern) according to an exemplary embodiment.

As shown schematically in FIG. 3, trim component 200 comprises a substrate 4, a barrier layer 2 and a cover 1. According to an exemplary embodiment, barrier layer 2 may be applied to the reverse side of leather material 1 prior to the plastic being injected on the reverse side of leather material 1. According to an exemplary embodiment, barrier layer 2 may be a film layer; barrier layer 2 is configured to be impervious to the plastic material.

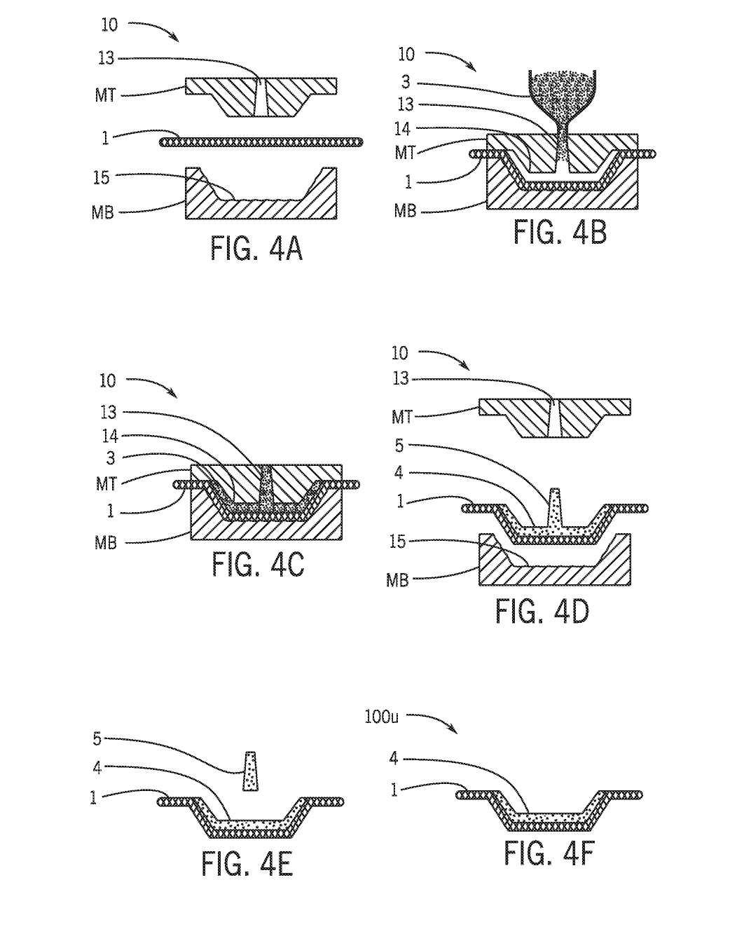

As shown schematically in FIG. 4A, a mold 10 comprises a mold top MT and a mold bottom MB; mold top MT provides a nozzle 13. According to an exemplary embodiment, nozzle 13 is configured to provide a passage/channel for molten plastic to be injected into a mold cavity between mold top MT and mold bottom MB. As shown schematically in FIG. 4A, a leather material 1 is places between mold top MT and mold bottom MB. According to an exemplary embodiment, leather material 1 (e.g. tanned but untreated) is moistened prior to being introduced into mold 10.

According to an exemplary embodiment, as shown schematically in FIG. 4A, mold bottom MB provides a surface 15. According to an exemplary embodiment, surface 15 may be configured to provide an embossed pattern or debossed pattern on the visible surface (i.e. exterior surface) of leather material 1. According to an exemplary embodiment, an embossed pattern is raised against the background of the leather material; a debossed pattern is sunken into the surface of the leather material; a debossed pattern may also protrude on the reverse/back side of the leather material. As shown schematically in FIGS. 4B and 4C, mold 10 is in a closed position; molten plastic 3 is injected into a mold cavity 14 formed between mold top MT and mold bottom MB at the closed position. As shown schematically in FIG. 4C, molten plastic 3 will not substantially permeate the reverse/back side of leather material 1; the pressure from the injected molten plastic 3 pushes leather material 1 against surface 15 of mold bottom MB. According to an exemplary embodiment, surface 15 may be configured to provide an embossed pattern or debossed pattern on the visible surface (i.e. exterior surface) of leather material 1.

As shown schematically in FIG. 4D, a hardened plastic part shown as a substrate 4 for the trim component is formed from molten plastic 3. As shown schematically in FIG. 4D, substrate 4 comprises a protrusion shown as a sprue 5 (e.g. along the fill channel). According to an exemplary embodiment, sprue 5 is a section of plastic within nozzle 13. As shown schematically in FIG. 4E, sprue 5 is removed after substrate 4 is formed. As shown schematically in FIG. 4F, a formed component 100u is formed; formed component 100u comprises a leather material 1 as a cover and a plastic material shown as substrate 4. According to an exemplary embodiment, leather material 1 on formed component 100u is uncolored; a color finish and/or a protective coating may be applied to leather material 1 in subsequent process steps.

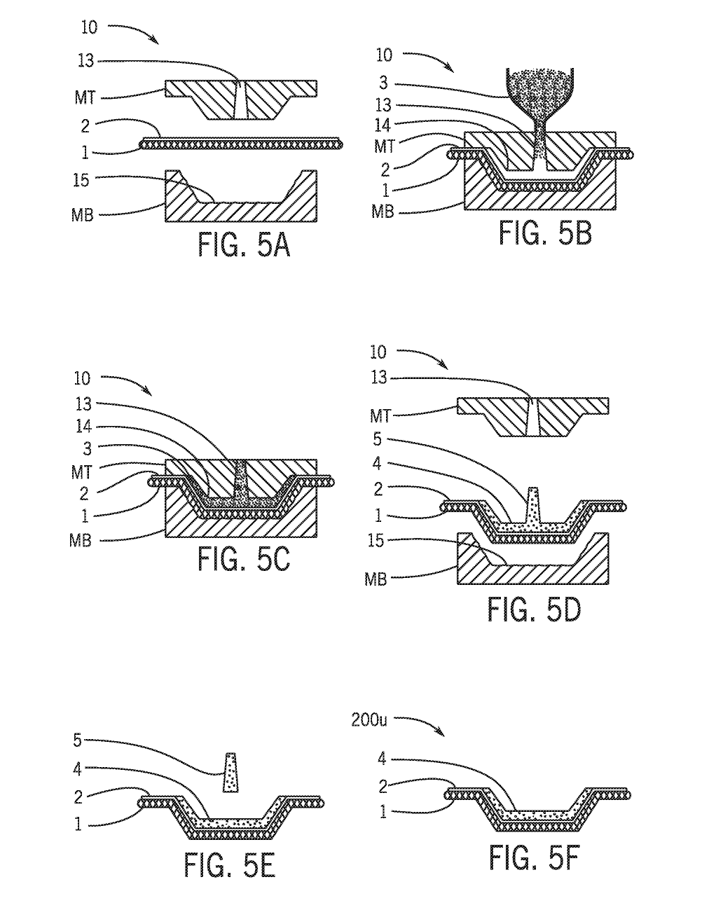

As shown schematically in FIG. 5A, a mold 10 comprises a mold top MT and a mold bottom MB; mold top MT provides a nozzle 13. According to an exemplary embodiment, nozzle 13 is configured to provide a passage/channel for molten plastic to be injected into a mold cavity between mold top MT and mold bottom MB. As shown schematically in FIG. 5A, a leather material 1 is places between mold top MT and mold bottom MB. According to an exemplary embodiment, leather material 1 (e.g. untreated) is moistened prior to being introduced into mold 10.

According to an exemplary embodiment, as shown schematically in FIG. 5A, mold bottom MB provides a surface 15. According to an exemplary embodiment, surface 15 may be configured to provide an embossed pattern or debossed pattern on the visible surface (i.e. exterior surface) of leather material 1. According to an exemplary embodiment, an embossed pattern is raised against the background of the leather material; a debossed pattern is sunken into the surface of the leather material; a debossed pattern may also protrude on the reverse/back side of the leather material. According to an exemplary embodiment, prior to introducing the molten plastic into mold 10, the reverse/back side of leather material 1 is coated with a barrier layer 2 (e.g. a barrier film, etc.); barrier layer 2 is impervious to plastic material according to an exemplary embodiment.

As shown schematically in FIGS. 5B and 5C, mold 10 is in a closed position; molten plastic 3 is injected into a mold cavity 14 formed between mold top MT and mold bottom MB at the closed position. As shown schematically in FIG. 5C, molten plastic 3 could not permeate the reverse/back side of leather material 1; the pressure from the injected molten plastic 3 pushes leather material 1 against surface 15 of mold bottom MB. According to an exemplary embodiment, surface 15 may be configured to provide an embossed pattern or debossed pattern on the visible surface (i.e. exterior surface) of leather material 1. See e.g. FIG. 2C.

As shown schematically in FIG. 5D, a hardened (e.g. cured) plastic part shown as a substrate 4 for the trim component is formed from molten plastic 3. As shown schematically in FIG. 5D, substrate 4 comprises a protrusion shown as a sprue 5. According to an exemplary embodiment, sprue 5 is a section of plastic within nozzle 13. As shown schematically in FIG. 5E, sprue 5 is removed after substrate 4 is formed. As shown schematically in FIG. 5F, a formed component 200u is formed; formed component 200u comprises a leather material 1 as a cover, a plastic material shown as substrate 4, and a barrier layer 2 between leather material 1 and substrate 4. According to an exemplary embodiment, leather material 1 on formed component 200u is uncolored; a color finish and/or a protective coating may be applied to leather material 1 in subsequent process steps.

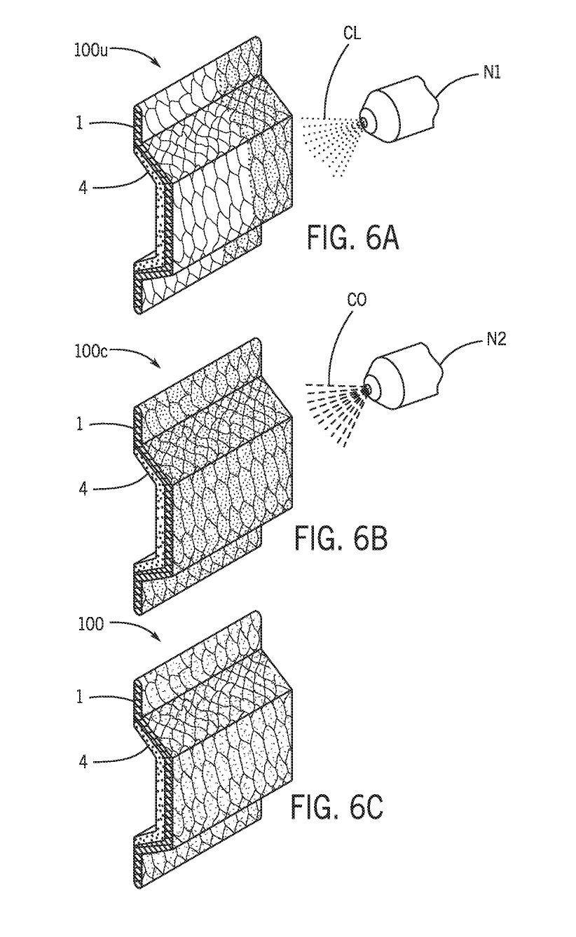

As shown schematically in FIG. 6A, formed component 100u comprises a leather material 1 as the cover and a plastic material 4 as the substrate for formed component 100u. As shown schematically in FIG. 6A, an embossment pattern is applied to the surface of leather material 1 by surface 15 of mold bottom MB during the injection molding process (see FIGS. 4A to 4D). As shown schematically in FIG. 6A, a color finish CL is applied to the exterior surface (i.e. the surface visible to vehicle occupants) of leather material 1 by a nozzle N1. According to an exemplary embodiment, the color finish may be applied to the exterior surface of the leather material by any method known to the art. According to an exemplary embodiment, the color finish can be any color specified by a customer. As shown schematically in FIG. 6B, a protective coating CO is applied to color finish CL of leather material 1 of a colored component 100c by a nozzle N2; the protective coating is a clear coating according to an exemplary embodiment. According to an exemplary embodiment, the protective coating may be applied to the color finish on the leather material by any method known to the art. As shown schematically in FIG. 6C, a finished component 100 is formed. According to an exemplary embodiment, finished component 100 comprises a leather material 1 as the cover coupled to a substrate 4 made from a plastic material.

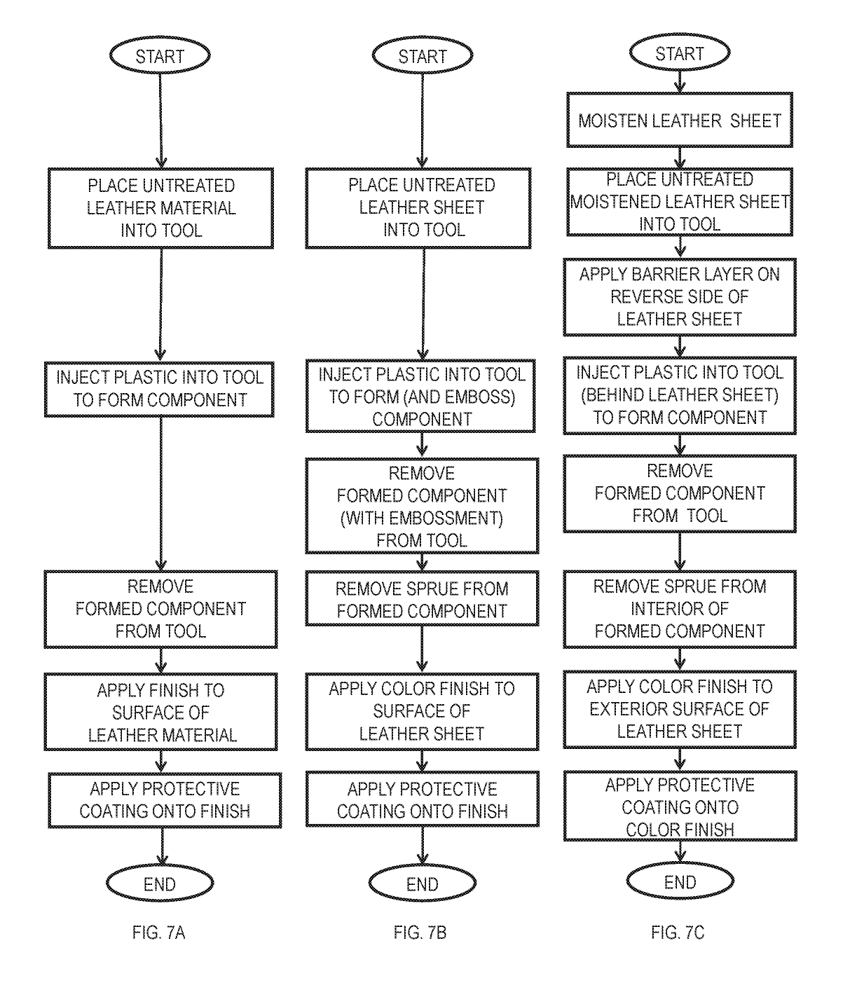

As shown schematically in FIG. 7A; a method for forming a trim component may comprise the process steps of (1) placing untreated leather material into tool; (2) injecting plastic into tool to form component; (3) removing formed component from tool; (4) applying finish to surface of leather material; (5) apply protective coating onto finish.

As shown schematically in FIG. 7B; a method for forming a trim component may comprise the process steps of (1) placing untreated leather sheet into tool; (2) injecting plastic into tool to form (and emboss) component; (3) removing formed component (with embossment) from tool; (4) removing sprue from formed component; (5) applying color finish to surface of leather sheet; (6) apply protective coating onto finish.

As shown schematically in FIG. 7C; a method for forming a trim component may comprise the process steps of (1) moistening (untreated) leather sheet; (2) placing untreated moistened leather sheet into tool; (3) applying barrier layer on reverse side of leather sheet; (4) injecting plastic into tool (behind leather sheet) to form component; (5) removing formed component from tool; (6) removing formed component from tool; (7) removing sprue from interior of formed component; (7) applying color finish to exterior surface of leather sheet; (5) apply protective coating onto finish.

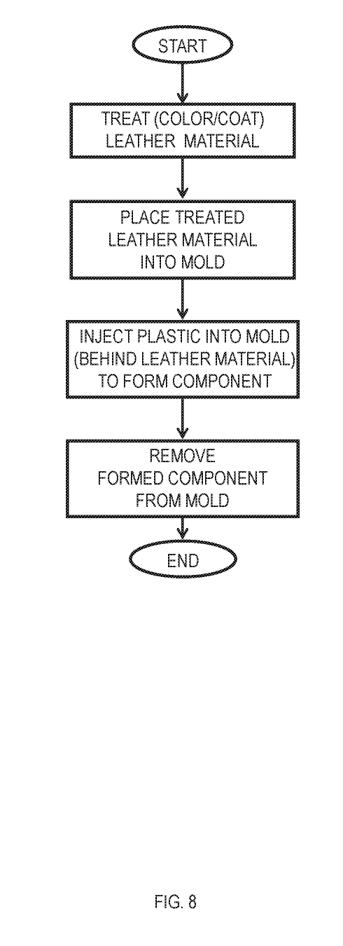

As shown schematically in FIG. 8; a method for forming a trim component may comprise the process steps of (1) treating (e.g. coloring, coating, etc.) leather material; (2) placing treated leather material into mold; (3) injecting plastic into mold (behind leather material) to form component; (4) removing formed component from mold; the method of FIG. 8 is a generally conventional method in which the leather material is treated (e.g. stretched, etc.) prior to the operation (e.g. in a separate process).

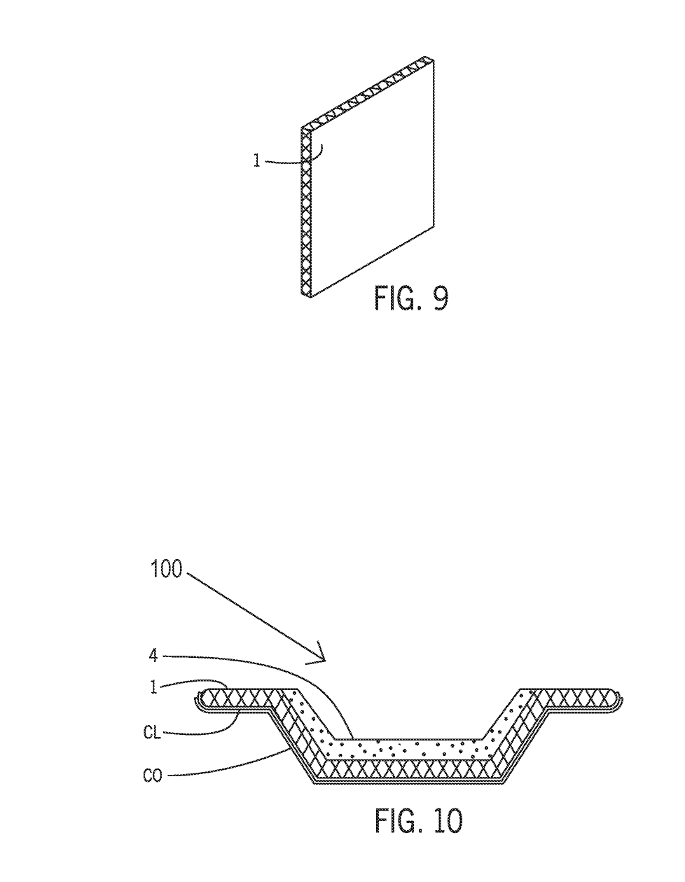

As shown schematically in FIG. 9, leather material 1 may be a leather sheet. According to an exemplary embodiment, the leather sheet is an uncolored and upstretched dried leather sheet prior to being place into the tool (e.g. mold, etc.).

As shown schematically in FIG. 10, a finished trim component 100 comprises a leather material 1 coupled to substrate 4. According to an exemplary embodiment, leather material 1 may be embossed; a color finish CL is applied to the exterior surface of leather material 1; a protective coating CO is applied to color finish CL.

### Exemplary Embodiments

The present invention relates to a method for producing a trim component such as a multilayer molded bodies. The present invention also relates to a molded body able to be produced by the method.

Vehicle interior component are a substantial factor in the visual appearance of the vehicle and on the feel and interplay between material and form and color of the interior. High-quality vehicle interiors comprise high quality design and materials used to produce the interior components. Leather is frequently used in the vehicle interior of high-priced and mid-priced vehicles. The processing of genuine leather is demanding; problems may arise in laminating of plastic components with leather, positioning of seams, and in joining the leather material to the predominantly soft plastic subsurface.

According to an exemplary embodiment, in-mold injection molding readily and easily joins the plastic subsurface to the cover material (e.g. leather material) and is a molding method for producing multilayer molded bodies. The in-mold injection method is used to produce composite components from a cover material (e.g. leather) and a plastic substrate in order to enable economical manufacture of high-quality components.

Processing genuine leather by in-mold injection molding is well known. The plastic melts to infiltrate into the leather forming a durable laminate. A durable laminate can be obtained from the plastic substrate and the genuine leather; the leather is subject to high tensile loads which diminishes its suppleness and visible characteristic grain. The high injection pressures (develops during the in-mold injection process) seal off the pores of the skin and result in a surface having a “plastic-like” look and feel.

The present invention is based on the task of specifying a method for producing multilayer molded bodies which enables plastic parts to be economically laminated with leather material so as to be visually and functionally flawless.

The present invention relates in particular to a method for producing multilayer molded bodies in which a reverse side of a leather material is plastic backed by injection molding. The method first provides a flat, unfinished leather material. The unfinished (e.g. untreated) leather material is a leather product (tanned) not yet fully stretched and/or treated (e.g. crust leather). The flat, unfinished (e.g. untreated) leather material is introduced into an injection mold; the reverse side of the leather material (also called the flesh side) is aligned toward an injection chamber of the injection mold. The melted plastic material is introduced into the injection chamber of the injection mold under pressure so that the plastic material can join to the reverse side of the leather material; the leather material is pressed onto the mold surfaces of the injection mold by the injection pressure and adapts to the surface of the multilayer molded part to be manufactured.

According to an exemplary embodiment, with treating the tanned leather material prior to insertion into the injection mold results in no tensile load on the leather material prior to insertion into the mold. Minimum tensile load is introduced into the leather material which is inevitable when inserting (e.g. fixing) the leather material in the injection mold. This ensures that the leather material is sufficiently flexible and has sufficient thickness for the subsequent injection molding process.

The unfinished (e.g. untreated) leather material has enough elasticity to withstand the high injection pressures during the in-mold injection process without causing any substantial changes to the leather surface (e.g. the leathers characteristic/natural grain or appearance). Since the leather material does not have any colored or protective coatings prior to the in-mold injection process; the high temperatures during the in-mold injection process does not pose a substantial problem for forming the component. The method enables the desired multilayer molded bodies to be produced in a few process steps.

According to an exemplary embodiment, embossing the surface of the leather material is desirable. The method provides for introducing embossing in or on the leather material during the melted plastic material being introduced; the injection mold can exhibit an at least partially textured mold surface to be used as an embossing surface. Depending on the design of the injection mold, the upper part and/or the lower part of the mold can be formed with such a textured embossing surface. (It is also conceivable for the in-mold injection to not encompass embossing; it is expedient to subsequently provide the three-dimensionally formed leather molded article with a desired embossing.)

The method provides for the leather material to be cut from a dried leather prior to be inserted into the injection mold. Drying serves to simplify the cutting of the leather material which occurs either subsequent to the in-mold injecting or automatically during the in-mold injecting.

According to an exemplary embodiment, the method provides for a tanned leather as the leather material; all commonly known types of leather can be used. Standard automotive, garment, shoe and split leather are particularly applicable. Leathers tanned using metal salt (e.g. chrome, aluminum) as well as leathers free of metal salts can be used. The leather material is unfinished prior to being introduced into the injection mold. According to an exemplary embodiment, the leather material is subjected to no drawing process leaving residual stretching (prior to being introduced into the injection mold).

According to an exemplary embodiment, the leather material is moistened prior to being inserted into the mold. The moistening of the leather material can occur automatically with water. The leather material can be moistened by water vapor during the injection molding process, achieving a cooling of the leather material during the injection process. According to an exemplary embodiment, the leather material may be separately moistened prior to insertion into the injection mold. The leather material can be passed through a water bath (e.g. on a conveyor belt). The temperature of the water used for moistening can be between 20 degrees and 50 degrees (e.g. for example approximately 35 degrees).

The leather material provided for the method is left in an untreated form before being introduced into the injection mold. The leather material is essentially subjected to no drawing process nor provided with any surface staining. According to an exemplary embodiment, the method provides for the surface of the leather material opposite from the plastic being provided with a color finish after the molded body is removed from the injection mold. According to an exemplary embodiment, a further protective layer can be applied subsequent to the color finish application to extend the life of a color coating (particularly in the form of a clear lacquer atop the color finish). According to an exemplary embodiment, the color finish and/or the protective coating can be applied as a spray coating; the spray coating can be applied by automatic spray applicators and/or manual spray guns.

According to an exemplary embodiment, prior to the introduction of the melted plastic material, the reverse side of the leather material is coated with a barrier layer (e.g. a barrier film) which is resistant to the plastic material. When the pressures and/or the temperatures developed during the in-mold injection process are elevated, the fibers within the leather can (possible irreversibly) stick together; substantially untreated leather material may prevent from sticking together of fibers. It can still be advantageous for a barrier film to be applied to the reverse side of the leather material. Barrier film can be used to protect against the molten plastic from moving through the joining and/or decorative seams of the leather material. The barrier layer configured as a barrier film can be formed from a foamed plastic (e.g. polyolefin, polypropylene, etc.). It is advantageous for the barrier layer to be configured as a self-supporting structure which already exhibits a form corresponding to the contour of the multilayer molded body to be produced (e.g. an instrument panel, etc.). According to an exemplary embodiment, designing the barrier layer as a self-supporting structure can reduce slipping of the leather material during the in-mold injection process to a minimum.

According to an exemplary embodiment, the melted plastic material is introduced into the injection mold at a temperature of 170 degrees Celsius to 250 degrees Celsius; the temperature range ensures sufficient bonding between the plastic material and the leather material during the in-mold injection process; temperatures are low enough to avoid damaging the leather fibers.

According to an exemplary embodiment, a thermoplastic is used as the plastic material (e.g. polyolefin, polypropylene, etc.); thermoplastic materials typically/generally have particularly long-term stability and guarantee the desired haptics of the multilayer molded body to be produced; indentation hardness of the finished molded body can be varied depending on the hardness of the thermoplastic. Soft thermoplastics are used in producing armrests; harder thermoplastics are used in producing instrument panels.

According to an exemplary embodiment, a multilayer molded body (e.g. an interior fitting for vehicles) comprises a plastic molded component to which a leather material is affixed; the component comprises genuine leather material which is plastic backed by in-mold injection molding; the surface of the genuine leather is finished after the in-mold injection process in a subsequent finishing process and/or coated in a subsequent coating process and protected.

According to an exemplary embodiment, the processing technique is intended to ensure that the in-mold injection molding process does not or not irreversibly damage the leather since the surface of the genuine leather material is not finished and/or coated until after the in-mold injection process. According to the exemplary embodiment, the process enhances (e.g. substantially enables) the feel of the leather or leather material and/or the grain of the leather or leather material and/or the appearance of the leather or leather material to also either be preserved subsequent the in-mold injecting and/or in-mold injecting process being realized or be produced and/or restored when realizing the subsequent finishing process.

According to an exemplary embodiment, the method is intended to provide an advantage of being able to cover and remedy general surface imperfections in the leather in the subsequent finishing process on the leather/leather material, or the surface of the leather/leather material, or in the subsequent coating process of the leather/leather material or the surface of the leather/leather material. See e.g. FIGS. 2A and 2C.

According to an exemplary embodiment, the material used for the in-mold injection molding process is a leather material (a genuine leather material) which has not yet been coated prior to the in-mold injection process. The injection pressure and/or high temperatures (e.g. approximately 170 degrees Celsius to approximately 250 degrees Celsius) do not normally damage the surface of the leather or the genuine leather material. According to an exemplary embodiment, the surface of the leather or genuine leather material undergoes the finishing process (e.g. typically coating) subsequent to the in-mold injection process. According to an exemplary embodiment, the process prevents damage to the finish coatings as well as preserves the grains and the feel of the leather.

According to an exemplary embodiment, the in-molded plastic material is also referred to as the base of the interior fitting, the molded body of the interior fitting or as the substrate of the interior fitting. The base or molded body or substrate can consist of a fiber-reinforced or filled olefinic plastic and be produced by injection molding.

According to an exemplary embodiment, the component such as trim component or interior fitting is manufactured by means of a mold having a first part and a second part; the first part of the mold and the second part of the mold together enclose a cavity of the mold (when the mold is closed). The mold in an opened state will provide the first part of the mold and the second part of the mold typically positioned at a relative distance to one another; the mold has an opening for the inserting of the genuine leather material. The genuine leather material is inserted into the mold in the interior fitting production method (e.g. the genuine leather material is inserted in the opened state of the mold).

According to an exemplary embodiment, after the genuine leather material has been inserted into the mold, the mold is closed (e.g. the first part of the mold and the second part of the mold move toward one another); the parts of the mold enclose the cavity; the cavity is sealed or at least largely sealed (from the leakage of the material to be in-mold injected) in relation to the exterior of the mold. The cavity is not fully filled with the genuine leather material; there is a partial volume within the cavity enclosed by the parts of the mold which is to be filled with the in-mold injected material. According to an exemplary embodiment, the material and/or plastic material injected into the cavity is only injected from one side of the genuine leather material (injection side of the cavity) causing the material injected into the cavity to press the genuine leather material to the side of the cavity (opposite the injection side).

According to an exemplary embodiment, the genuine leather material is either inserted into the mold as a two-dimensional material or as a semi-finished material (being brought into a three-dimensional form prior to insertion and/or being inserted in a preformed shape).

According to an exemplary embodiment, to produce the finished interior fitting (e.g. trim part, vehicle trim part, etc.) the leather material is joined to a plastic base or substrate.

According to an exemplary embodiment, different in-mold injecting materials or combinations of in-mold injecting materials are utilized. According to an exemplary embodiment, the plastic base is a polypropylene plastic base having fillers or reinforcing material (e.g. fibers, etc.); the plastic base can either be completely foamed or only foamed in sections. An ABS material (acrylonitrile butadiene styrene) and/or a PC material (polycarbonate) may also be used.

According to an exemplary embodiment, the base material of the molded body (polypropylene plastic or ABS/PC plastic) are commercially available synthetic materials with up to 30 percent added glass fibers and/or up to 30 percent added talcum; both materials may be added up to a ratio of 50 percent and in all cases the actual plastic content (i.e. the percentage of polypropylene in the case of a polypropylene-based plastic base or the percentage of ABS/PC in the case of an ABS/PC-based plastic base) amounts to at least 50 percent.

According to an exemplary embodiment, the substrate of the molded body may be a molten-processed thermoplastic material (i.e. processed as a molten mass). The molten-processed material may consist of polypropylene (PP), acrylonitrile butadiene styrene (ABS), a mixture of ABS and polycarbonate (PC), polyamide (PA), a thermoplastic elastomer (TPE) or a natural rubber and/or polypropylene (PP) based thermoplastic elastomer. The molten-processed material may consist of a mixture of at least two of these materials.

It may be advantageous for the molten-processed material to comprise fillers (e.g. talcum, chalk and wollastonite). The molten-processed material may comprise reinforcing materials (e.g. glass fibers, natural fibers, carbon fibers or textile-like reinforcements such as glass fiber matting or natural fiber matting) for the purpose of increasing its mechanical stability. It may be advantageous for pore-forming (e.g. physical or chemical) foaming agents or gas-charged elastomeric balls to be added to the molten-processed material.

As shown schematically in FIG. 4A, an unfinished leather material 1 is introduced into the interior of an injection mold 10. According to an exemplary embodiment, the leather material is initially uncoated and is not subjected to any drawing process leaving residual stretching prior to being introduced into mold 10. The leather material can be a tanned natural leather; a tanned natural leather is dried and cut prior to being inserted into the injection mold 10 (making it a suitable dimension for the molded body to be produced).

According to an exemplary embodiment, leather material 1 can be slightly moistened prior to being introduced in injection mold 10. Leather material 1 is then inserted into injection mold 10; the reverse side of leather material 1 is aligned toward an injection chamber 14. The surface of leather material 1 must fit as tightly as possible to a mold surface 15 of a mold bottom MB of mold 10. Leather material 1 can be manually pressed against mold surface 15; negative pressure channels can be provided under mold bottom MB which tightly draws in leather material 1 to mold surface 15.

As soon as leather material 1 is fit to mold surface 15 of mold bottom MB, a mold top MT of mold 10 is closed; a boundary region of leather material 1 is clamped between the upper part of injection mold 10 and the lower part of injection mold 10; the shape of mold top MT and mold bottom MB of injection mold 10 forms injection chamber 14 (at the reverse side of leather material 1). As shown schematically in FIG. 4A, mold top MT of injection mold 10 comprises a nozzle 13 through which pressurized molten plastic material 3 can be introduced into injection chamber 14. Molten plastic material 3 is formed as thermoplastic material is introduced into injection chamber 14 under high pressure and at temperatures of between 170 degrees Celsius and 250 degrees Celsius; leather material 1 is stretched and fully pressed against mold surface 15. According to an exemplary embodiment, leather material 1 has not been curried prior to being introduced into the injection mold 10 (the surface is not damaged by the compressive load prevailing).

According to an exemplary embodiment, sections of the mold surface 15 exhibit a structuring able to be utilized as an embossing surface; pressure already produces an embossing on the front side of the leather material during the in-mold injecting process.

As shown schematically in FIG. 4D, after molten plastic material 3 has cooled down, the multilayer molded body is removed from the injection mold. As shown schematically in FIG. 4D, the reverse side of hardened plastic part 4 exhibits a sprue shown as a protrusion 5; protrusion 5 corresponds to the shape of nozzle 13 of mold 10. According to an exemplary embodiment, protrusion 5 is removed from the remainder of plastic part 4. After the multilayer molded body is removed from injection mold 10 the multilayer molded body may be provided with a color finish and/or protective coating. Other embellishings may also be placed on the outer side of leather material 1 once the molded body is removed from mold 10.

According to an exemplary embodiment, a barrier layer (e.g. a barrier film) is applied to the reverse side of leather material 1 prior to molten plastic material 3 being introduced into the mold; a barrier layer (e.g. a barrier film) is applied so that at least some areas of molten plastic material 3 do not come into contact with the reverse side of leather material 1. See FIGS. 5A to 5F.

It is important to note that the construction and arrangement of the elements of the inventive concepts and inventions as described in this application and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

It is important to note that the apparatus of the present inventions can comprise conventional technology (e.g. as implemented in present configuration) or any other applicable technology (present or future) that has the capability to perform the functions and processes/operations indicated in the FIGURES. All such technology is considered to be within the scope of the present inventions and application.

1. A method for producing a trim component for a vehicle interior comprising a leather material backed with a plastic material in an apparatus comprising a tool comprising the steps of:
(a) placing an untreated leather material into the tool;
(b) introducing molten plastic material into the tool to form a formed component comprising the leather material and the plastic material; and
(c) removing the formed component from the tool.

2. The method of claim 1 wherein the untreated leather material comprises leather that is tanned.

3. The method of claim 1 wherein embossing is introduced in or on the leather material by the tool.

4. The method of claim 1 wherein a surface of the leather material provided with a color finish after the formed component is removed from the tool.

5. The method of claim 4 wherein a protective coating is applied to the color finish after application of the color finish.

6. The method of claim 1 wherein the formed component comprises a multilayer molded body of thermoplastic material and leather material.

7. The method of claim 1 wherein the untreated leather material comprises at least one of (a) tanned leather; (b) uncolored leather; (c) scrap leather; (d) crust leather.

8. The method of claim 1 wherein the leather material is at least one of (a) unstretched and untreated; (b) flat and uncurried; (c) cut from dried leather.

9. The method of claim 1 wherein the apparatus comprises an injection mold and the plastic material is introduced under pressure into a chamber of the injection mold.

10. The method of claim 9 wherein the leather material is placed on the tool such that a back side of the leather material is aligned toward the chamber of the injection mold.

11. The method of claim 10 wherein prior to the introduction of the molten plastic material the back side of the leather material is coated with a barrier layer; wherein the barrier layer comprises a barrier film impermeable to the plastic material.

12. The method of claim 1 wherein the leather material undergoes minimal drawing with residual stretching prior to being placed into the tool.

13. The method of claim 1 wherein the leather material is moistened prior to being placed into the tool.

14. A trim component made by a method comprising the steps of:
(a) placing an untreated leather material into the tool;
(b) introducing a molten plastic material into the tool to form a formed component comprising the leather material on the plastic material; and
(c) removing the formed component from the tool;
wherein the untreated leather material comprises leather that is tanned.

15. The trim component of claim 14 wherein the untreated leather material comprises leather that has elasticity to withstand being formed into the formed component.

16. The trim component of claim 14 wherein embossing is introduced in or on the leather material by the tool.

17. The trim component of claim 14 comprising a painted formed component.

18. The trim component of claim 14 wherein the leather material is affixed to a plastic material to form a molded body of the formed component.

19. The trim component of claim 14 comprising the formed component coated with one of (a) a paint and (b) a coating; and wherein the coating comprises at least one of (1) abrasion protection; (2) ultra-violet light protection; (3) glass finish; (4) matte finish; (5) color; (6) humidity or moisture resistant material; (7) clear coating; (8) varnish; (9) protective coating.

20. The trim component of claim 14 wherein the plastic material comprises at least one of (a) a thermoplastic material; (b) polypropylene; (c) polyolefin.

21. A method for producing a trim component for a vehicle interior comprising a leather material backed with a plastic by injection molding in an apparatus comprising a tool comprising the steps of:
(a) providing an untreated leather material;
(b) placing the untreated leather material into the tool;
(c) introducing a molten plastic material into the tool to form a formed component comprising the leather material on the plastic material; and
(d) removing the formed component from the tool;
wherein embossing is introduced in or on the leather material by the tool; and
wherein the untreated leather material comprises leather that is tanned.

22. The method of claim 21 wherein embossing is introduced substantially during introducing of the molten plastic material.
